(19) United States
(12) Patent Application Publication
(10) Pub. No.: US 2025/0214144 A1
(43) Pub. Date: Jul. 3, 2025

(54) POWER BED FUSION ADDITIVE MANUFACTURING WITH LOAD BALANCING FOR MULTIPLE BEAMS

(71) Applicant: Nikon SLM Solutions AG, Lübeck (DE)

(72) Inventor: Jan Lukas Matyssek, Lübeck (DE)

(73) Assignee: Nikon SLM Solutions AG, Lübeck (DE)

(21) Appl. No.: 19/085,280

(22) Filed: Mar. 20, 2025

Related U.S. Application Data
(63) Continuation of application No. 18/489,164, filed on Oct. 18, 2023, now Pat. No. 12,257,627.
Application No. 18/489,164 is a continuation of application No. PCT/EP2022/059930, filed on Apr. 13, 2022.

(30) Foreign Application Priority Data
Apr. 21, 2021 (DE) 10 2021 110 091.7

(51) Int. Cl. B22F 10/85; B22F 10/28; B29C 64/153; B29C 64/282; B29C 64/371; B29C 64/393; B33Y 10/00; B33Y 30/00; B33Y 50/02

(52) U.S. Cl. CPC B22F 10/85; B22F 10/28; B29C 64/153; B29C 64/282; B29C 64/371; B29C 64/393; B33Y 50/02; B33Y 10/00; B33Y 30/00

(57) ABSTRACT

A method for manufacturing a workpiece comprising fusing an area (A) of a layer of a fusable material by irradiating the surface of the area (A) of the layer using a number n, n≥2 of at least two beam sources to project a corresponding number of n beam spots on n sets of locations (Lᵢ) of said surface area (A) of the layer, wherein each beam source has a predefined fuse rate (Rᵢ) and a field of view (Fᵢ),

$$\vert {L}_{i} ⋂ {L}_{j} \vert \leq \frac{1}{100} Max ( \vert {L}_{i} \vert , \vert {L}_{j} \vert ) , ∀ i \neq j$$

and the indices of Lᵢ, Rᵢ and Fᵢ symbolize the respective beam source, i.e. 0<i≤n and the set of all beam source indicating indices is I={1, . . . , n} operates more efficiently if first an optimum fusing time tₒ(i) for the area (A) and at least for the first beam source, i.e. for at least a first index i=1, is estimated, intersecting sets (ISᵢ) of the surface area (A) and the fields of view (Fᵢ) for at least a first index i=1 are determinated by assigning at least IS₁:=A∩F₁. This enabled to compare the size of the intersecting sets (|ISᵢ|) to the product of the optimum mean fusing time tₒ(i) with the fuse rate Rᵢ of the corresponding i^{th}-beam source and if the relation tₒ·Rᵢ<|ISᵢ| holds true, then a subtrahend surface Sᵢ may be determined which obeys Sᵢ⊂ISᵢ and (1−αᵢ)(|ISᵢ|−tₒ·Rᵢ)≤|Sᵢ|≤(1+αᵢ)(|ISᵢ|−tₒ·Rᵢ), wherein αᵢ∈{0.25 0.2, 0.15, 0.1, 0.05, 0.025, 0.01,0.005,0} under the condition that for each \vec{p}ᵢ∈Sᵢ, ∃Fₖ|\vec{p}ᵢ∈Fₖ, k>i. Next the set of locations Lᵢ:=ISᵢ−Sᵢ may be assigned which can then be fused using the i^{th}-beam source.

### CROSS-REFERENCE TO RELATED APPLICATIONS

This US Patent Application is a continuation of the pending U.S. patent application Ser. No. 18/489,164 filed on Oct. 18, 2023 and now published as US 2024/0246150, which is a continuation of the International Patent Application No. PCT/EP2022/059930 filed on Apr. 13, 2022 and now published as WO 2022/223411, which designates the United States and claims priority from the German Patent Application No. DE 10 2021 110 091.7 filed on Apr. 21, 2021. The disclosure of each of the above-identified patent documents is incorporated herein by reference.

### BACKGROUND

### 1. Field of the Invention

The invention relates to a method and an apparatus for the powder bed fusion process and to a storage medium including instructions to execute the method.

### 2. Description of Related Art

There are a number of additive manufacturing techniques, as well referred to as 3D- printing processes. One of these techniques is the so-called powder bed fusion process. Very briefly summarizing, the powder bed fusion process consists of iteratively applying a powder layer onto a support structure and selectively adhering powder particles to another or previously adhered agglomerates by heating the respective particles using an electron beam, a laser beam or any other kind of radiation beam (hereinafter jointly “beam” for short). Adhering particles of a powder bed by scanning a surface of the powder bed with a beam is referred to as fusing, regardless of the physical or chemical process (melting, sintering, welding, radiation induced chemical reaction, . . . ) that provides the result of adhered particles. Vividly speaking, sectional views of the product to be manufactured are so to speak written and thus formed on each newly applied top layer by moving a beam spot over the surface of the upmost powder layer. The area of the powder bed in which the section view is formed may hence be considered as a forming region or a fusing region. By adding a new powder layer after each writing step a so-called powder bed is formed. Embedded in the powder bed is the already manufactured portion of the workpiece. Depending on the final product, sometimes additional auxiliary structures have to be “written” into the powder layer, but herein we do not focus on this aspect and we consider these to be a part of the workpiece. Once all layers have been written, the workpiece, potentially with its adhering auxiliary structures, may be removed from the powder bed and may be subjected to further processing, if required. The terms product and workpiece are used interchangeably in this field and hence herein.

The powder bed fusion process is very capable, but it is desirable to reduce the manufacturing times for a given workpiece. To this end, it has been suggested to use multiple beams which independently write a portion of each layer (i.e. a portion of the “sectional view”) of the workpiece onto each layer of the powder bed. Further, in particular in case the up-facing surface of the powder is increased to manufacture larger workpieces, multiple beams sourced can be distributed at different locations above the powder bed to reduce imperfections due to beam expansion and parallaxes. This approach, however, has limitations, for example fumes being produced by a first beam may interfere with another beam, which is detrimental to the quality of the product. Other problems are related to heat dissipation in the powder bed or to beam spot distortion. Beam spot distortion describes the effect of an increasing elliptic distortion of the beam spot formed on the powder bed as a function of increasing deviation of the angle of incidence from a near normal incidence.

WO 2016/075026 A suggests optimizing a multi beam laser powder bed fusion process by virtually separating the surface of a powder bed into a number of surfaces sections, wherein each beam illuminates and hence fuses powder particles in a single surface section being assigned to said beam. Once all beams finished writing on a layer, i.c. when the next powder layer can be applied to the powder bed, the run-times of each beam source, as well referred to as “beam-on times” of the different beam sources are compared and the boundaries between the surface sections are adjusted to compensate for differences in the run times. For example, if beam source No. 1 has a lower beam-on time than beam source No. 2, when writing the layer No. l, the boundary between the surface sections being associated to beam sources No. 1 and No. 2 are shifted to increase the surface area of the surface section associated to beam source No. 1 and to decrease the surface section associated to beam source No. 2. Thereby, idle times of the beam sources are reduced when fusing the next layer, i.e. layer No. l+1. Alternatively, the areas of the actually illuminated surfaces may be compared and based on the comparison the boundaries between the surface sections may be adjusted to compensate for differences in the actually illuminated surfaces.

WO 2020/178216 A suggests controlling the positions of the beam spots of a multi beam laser powder bed fusion process such that at—no point in time—any line connecting two beam spots is parallel to a flow direction of an inert gas flow over the powder bed.

DE 10 2013 205 724 A1 suggests improving the powder bed process by coordinating the direction in which the beam of a beam source scans a portion of the powder bed and the inert gas flow direction. This coordination can be obtained by limiting the angle of the scanning direction and the inert gas flow direction to the interval [22.5°, 337.5°], preferably to the interval [90° and 270°].

DE 10 2018 203 233 A1 suggests scanning a sectional view of a workpiece in the powder bed process by at least two lasers. Each laser is assigned a region of the sectional view, i.e. the respectively assigned region is scanned by the corresponding laser. The boundary between of these two neighbored regions of the sectional view is saw tooth line, to thereby increase the strength of the manufactured workpiece.

W0 2016/110 440 A1 as well relates to a multiple beam powder bed process. Each beam has a field of view and at least two of these fields of view are overlapping. To improve scanning speed, it is suggested to locate the sectional view to be irradiated by the beams at least in part in a portion of the powder bed in which the fields of view of at least two beams are overlapping. The sectional view is scanned by the beams at the same time, wherein the distance between the spots being irradiated at the same time is reduced over time until the irradiated spots of the beams at least partially, preferably fully overlap. The beam intensities are reduced with an increase of the overlap to maintain the energy being provided to each spot of the sectional view being scanned constant.

### SUMMARY OF THE INVENTION

The object of the invention is thus to further improve the multi beam powder bed fusion process with the object of reducing the cost for manufacturing a workpiece.

The invention is based on the observation that the prior art suggestions for defining the boundary between two adjacent surface sections of the surface of a top layer of a powder bed is based on the beam-on times measured when writing the previous layer. This process iteratively finds the optimum boundary position and hence leads to a significant cumulation of idle times. This approach is further increasingly inefficient, the more the surface areas to be illuminated in the different surface sections change from layer to layer.

The method for manufacturing a workpiece includes fusing an area A (“the area A”, for short) of a surface of a layer of a fusible material (“the layer”, for short). In practice, the layer may be the present upmost layer of a powder bed on top of a powder bed support of an additive manufacturing machine configured to use and/or to implement the powder bed fusion process. Once the area A of the of the top layer intended to be fused have been fused, the next layer may be applied to the powder bed, e.g. using a recoater. Initially, the upmost layer may be the first layer of the powder bed being subsequently deposited during the process.

As already apparent the term “area” does not necessarily denote the entire surface of the layer, but only a portion thereof that shall be fused. The symbol A thus represents a set of locations (points) that can be represented as vectors \vec{p}, all in the plane defined by the surface of the layer, which shall be and during the process are irradiated by at least one beam spot being emitted by a beam source. The symbol |A| hence symbolizes a value indicative for the size of the surface of the aera A, i.e. |A| is the surface area of the area A. Using the skilled person's language|A| is a norm, generally referred to as ||A||, only for simplicity we omit herein the second set of vertical bars.

The area A may be the entire area EA of the layer to be irradiated, but in another example, the area A may be only a portion thereof, i.e. A⊆EA. For example, those parts of the entire area EA to be irradiated that define, e.g., a portion of the contour of the workpiece may be subtracted from the entire area to thereby obtain “the area A”. The contour portions being subtracted may, for example, be irradiated always by the same beam source to increase the quality of the workpiece surface defined by said contour. Alternatively, or in addition, the ‘entire area’ EA may be divided in subareas, e.g. to improve fume management. As already stated “the area A” may be a subarea of the ‘entire area EA’. Generalizing, one may thus say that the area A may be at least a portion of a sectional view of the workpiece to be manufactured by application of the laser powder bed fusion process, wherein the section plane corresponds to the position of the layer of fusible material to be irradiated.

The area A may include multiple subareas, we call sectors to distinguish the sectors verbally from the previously discussed ‘subareas of the entire area to be irradiated’. The sectors may by spaced from each other, i.e. there may be a gap between neighboured sectors of the area A. Further, as already apparent, it is irrelevant for the invention to which layer the area A is associated. All that is required is that the area A can be irradiated by beams being emitted by the beam sources. When referencing to an area A on a particular layer, the symbol A^{l} may be used. Thus A¹ would be an area on the first layer of a powder bed, A² an area of subsequent layer of the powder bed, A^{l} is an area on the l^{th}-layer. If the up script is omitted this means that the position of the Area A in the sequence of layers is not relevant and may take any number.

The area A is typically determined by a so called “slicer” based on a CAD-model of the workpiece to be manufactured. But the invention is not limited to this example.

As already apparent from the wording fusing a surface area A of a layer of a fusible material, the method includes fusing the portion of the fusible material of the layer as defined by the surface area A. To this end at least two spots of at least two beams are projected by at least two beam sources onto the set of locations defining the surface area A. The method can be used in case there are only two beam sources, but practice the number may be higher. Typical values are, depending on the size of the layer, between 8 to 12, but the invention is not limited to this range. Future powder bed fusing apparatuses are expected to have even higher numbers of beam sources. Herein we symbolize the total number of beam sources being available by “n”. This number “n” of beam sources being available may be different from the number of beam sources of the powder bed fusion apparatus. For example, if one or more beam sources has or have been assigned the task of fusing a contour portion which is not a portion of the area A, then these assigned beam source(s) cannot contribute to fusing the area A, while fusing the respective contour portion(s). Once the assigned contour portions have been fused, these beam sources can be used to fuse sections of the area and the number “n”, hence can be increased. Another ground for a number “n” being smaller than the number of installed beam sources may be to reduce the thermal power that needs to be removed from the workpiece or simply because a section of the area would be so small that location management would be difficult. For example, if a section is very small, it can become almost impossible to avoid fusing the section while not operating in a smoke plume being produced by fusing the powder bed in another section. Thus, is short, the number “n” represents the number of lasers being assigned to jointly fuse an area A. As will become apparent below, the number may even change during the process of assigning locations of the area A to the sets of locations Lᵢ (1≤i≤n) which may then be fused by the corresponding i\hat{ }th-beam source. This may, e.g., happen if it turns out that the size of the area of a set of locations Lᵢ would be below a predefined threshold Tᵢ.

Each of the n, (n≥2) beam sources has a predefined field of view Fᵢ, wherein the index i indicates the corresponding i^{th}-beam source, e.g. F₁ is the field of view of the first beam source, F₂ is the field of view of the second beam source, or more generally Fᵢ is the field of view of the i^{th}-beam source. The field of view Fᵢ is the surface portion of the layer that can be irradiated by the corresponding i^{th}-beam being emitted by the i^{th}-beam source. In practice, each field of view Fᵢ may be defined by a scanner optic of the i^{th}-beam source. Constraints in the field of view Fᵢ may be imposed by pivot ranges of a scanner optic, limits of (optional) focussing optics and as well by a limit of the acceptable beam distortion. In general, the field of view Fᵢ can be understood as the portion of the layer that can be reasonably fused using the corresponding i^{th}-beam source. The field of view Fᵢ can thus be expressed as set of vectors \vec{f}ᵢ on the surface of the layer that can be irradiated and hence fused using the i^{th}-beam source. Thus, |Fᵢ| is the size of the portion of the surface of the layer that can be irradiated by the corresponding i^{th}-beam source. Further, each beam source i has a predefined fuse rate Rᵢ (a positive real number), wherein the fuse rate indicates the size of the surface field of view that can be fused by the i^{th}-beam source per unit of time. The fuse rate Rᵢ is a surface area per time and hence can be measured, e.g.

$$in \frac{{m}^{2}}{s} [ \frac{{meter}^{2}}{second} ]$$

or the like. For example, when fusing a surface, the beam spot often travels along a first vector, defining a first fuse trace until a stop condition is reached. Then the beam may be switched off and the beam source may be repositioned to a new start point. Next, the beam may be switched on again and the beam spot travel may travel, e.g. parallel to the previously fused fuse trace. Calculation of the fuse rate Rᵢ may thus account for the time being required to reposition the beam source. In practice the fuse rate Rᵢ can be considered as a mean fuse rate that may be determined iteratively with an increasing accuracy. The fuse rates Rᵢ may differ between different beam sources and may as well depend on a given material to be fused. At least for a given material, the fuse rates Rᵢ are preferably at least almost the same, meaning that (1±β_{R}_{ᵢ})Rᵢ=Rⱼ, ∀i≠j,i,j<n, wherein

$${β}_{{R}_{i}} ∈ \{ \frac{25}{100} , \frac{20}{100} , \frac{15}{100} , \frac{10}{100} \frac{5}{100} , \\ \frac{25}{1000} , \frac{1}{100} , \frac{5}{1000} , \frac{25}{10000} , \frac{125}{10000} , \frac{1}{1000} , 0 \} .$$

In another example, the fuse rate Rᵢ is simply the length (times the width) of a trace the i^{th}-laser scans per unit of time without accounting for the time required to reposition laser beam optics when starting a new trace.

Fusing the area A may include irradiating different sets Lᵢ of locations \vec{l}ᵢ on the layer using the i^{th}-beam source for the corresponding set of locations Li, wherein the intersection of different sets of locations may preferably be empty, i.e. preferably the relation Lᵢ∩Lⱼ={}=0, ∀i≠j holds. This means essentially, that each location \vec{p} of the area A may be fused only by a single beam source. Generally, it is preferred to use all beam sources of the powder bed fusing apparatus for fusing the area, but this is not required and, in some cases, not even possible (as explained above). Of course, the different sets of locations Lᵢ may be irradiated at the same time. In practice the trajectories of the projections of the beam spots of different beams sources may overlap, e.g. similar to the overlapping of sections of a single beam's trajectory to ensure a given strength and surface quality in those regions of the layer, where the final workpiece shall not have a gap. There have been suggestions to fuse using overlapping sets of locations, but herein this is-although not excluded-not intended. Intended is |Lᵢ∩Lⱼ|≤β_{L}·Max({|Li|, |Lⱼ|}), wherein

$${β}_{L} ∈ \{ \frac{25}{100} , \frac{20}{100} , \frac{15}{100} , \frac{10}{100} \frac{5}{100} , \\ \frac{25}{1000} , \frac{1}{100} , \frac{5}{1000} , \frac{25}{10000} , \frac{125}{10000} , \frac{1}{1000} , 0 \} ,$$

preferably β_{L}=0. Thus, generally, it may be intended to separate the area A into a number n sets of locations Lᵢ, wherein n indicates the number of beam sources that shall be used. Preferably, n indicates the number of beam sources having a field of view with a non-vanishing overlap with the area A, i.e. the number of different indices for which Fᵢ∩A≠{} in another example n indicates the number of beam sources having a field of view with an overlap with the area A being greater than a threshold T, i.e. only those beam sources are considered for which |Fᵢ∩A|≥Tᵢ.

Preferably, prior to fusing the area A, an optimum fusing time tₒ(i) may be determined (step 1.1). There are a number of possibilities to estimate an optimum fusing time tₒ(i), and in a preferred example the optimum fusing time can be determined by dividing the size of the area |A| by the sum of the fuse rates Rᵢ of all involved beam sources, hence

$${t}_{o} ( i ) = \frac{\vert A \vert}{{\sum }_{j = 1}^{n} {R}_{j}} , ∀ 1 \leq i \leq n .$$

In this case all beam sources would require the same amount of time to fuse their respective sets of locations Lᵢ, i.e. idle times are minimized. Other estimations may be used as well. For example, one may use

$${t}_{o} ( i ) = \frac{( 1 + {β}_{t , i} ) \vert A \vert}{{\sum }_{j = 1}^{n} {R}_{j}}$$

or

$${t}_{o} ( i ) = \frac{( 1 - {β}_{t , i} ) \vert A \vert}{{\sum }_{j = 1}^{n} {R}_{j}} ,$$

wherein

$${β}_{t , i} ∈ \{ \frac{25}{100} , \frac{20}{100} , \frac{15}{100} , \frac{10}{100} \frac{5}{100} , \\ \frac{25}{1000} , \frac{1}{100} , \frac{5}{1000} , \frac{25}{10000} , \frac{125}{10000} , \frac{1}{1000} , 0 \} ,$$

preferably β_{t,i}=0. Generalizing, any suited measure for an optimum fusing time tₒ(i) can be chosen, preferably tₒ(i) may be selected to obey

$$\frac{( 1 - {β}_{t , i} ) \vert A \vert}{{\sum }_{j = 1}^{n} {R}_{j}} \leq {t}_{o} ( i ) \leq \frac{( 1 + {β}_{t , i} ) \vert A \vert}{{\sum }_{j = 1}^{n} {R}_{j}} .$$

Thus, the optimum fusing time depends on the size of the surface area |A| to be fused, following the convention that an upscript indicates the number of a layer the optimum fusing time may as well be indicated as tₒ^{l}(i). Unless required we will omit the upscript as well as the indication of the associated beam source “(i)” for simplicity.

Equivalent to determining the optimum fusing time tₒ(i), one may as well or in addition determined the optimum size of a corresponding fusing area |Lᵢ^{opt}|. In a preferred example |Lᵢ^{opt}|=tₒ(i)·Rᵢ.

In addition, at least a first intersecting set IS₁ of the surface area A and the first field of view (F₁) of a first beam source may be determined, hence IS₁:=A∩F₁. (step 1.2). This is equivalent to determining those vectors of the area A on the surface of the layer that generally could be irradiated and hence subjected to fusing by the 1^{st}-beam source. Further intersecting sets ISᵢ may be determined as well, wherein ISᵢ is the intersecting set being associated to the i^{th}-beam source. In an example, ISᵢ may generally be defined as ISᵢ=A∩Fᵢ∀1≤i≤n. But as will be apparent below, other definitions may be used as well. Further, it should be noted, that an intersecting set ISᵢ, i≥2 may preferably be determined after the set of locations Lᵢ₋₁ has been determined as explained below. (Only for formal simplicity one may define L₀:={} or more generally Lⱼ:={}∀j≤0, ∀j>n.

In a further step, the size of at least the first intersecting set |IS₁| is compared to the product of the optimum fusing time tₒ(i) with the fuse rate Rᵢ of the corresponding i^{th}-beam source (step 1.3) and if the relation

tₒ(i)·Rᵢ<|ISᵢ| holds true, then a subtrahend surface S₁ with S₁⊂IS₁ and at least one of (1−α₁)·(|IS₁−tₒ(i)·R₁)≤|S₁|≤(1+α₁)·(|IS₁|−tₒ(i)·R₁) and its equivalent (1−αᵢ)(|IS₁|−|L₁^{opt}|)≤|S₁|≤(1+α₁)(|IS₁|−|L₁^{opt}|) may be determined wherein the condition that for each
\vec{p}₁∈S₁, ∃Fₖ|\vec{p}₁∈Fₖ, k∈{2, . . . , n} may be observed (step 1.3.1). α₁ can be considered as an error margin (hence α₁=0 is preferred) and is defined below in detail.

Again, by replacing the index 1 by the index i, the step may be generalized to obtain the i^{th} subtrahend surface Sᵢ being associated to the i^{th}-beam source, i.e. generalizing in case the condition tₒ(i)·Rᵢ<|ISᵢ| holds true, the i^{th}-subtrahend surface Sᵢ may be determined using the conditions Sᵢ⊂ISᵢ and (1−αᵢ)·(|ISᵢ|−tₒ(i)·Rᵢ)≤|Sᵢ|≤(1+αᵢ)(|ISᵢ|−tₒ(i)·Rᵢ) (and/or (1−αᵢ)(|ISᵢ|−|Lᵢ^{opt}|)≤|Sᵢ|≤(1+αᵢ)(|ISᵢ|−|Lᵢ^{opt}|)) that for each \vec{p}ᵢ∈Sᵢ, ∃Fₖ|\vec{p}ᵢ∈Fₖ, k>i} may be obeyed, wherein αᵢ∈{0.25, 0.2, 0.15, 0.1, 0.05, 0.025, 0.01, 0.005, 0}. Smaller values of αᵢ are preferred, in a particular preferred example αᵢ=0. If αᵢ=0, then the constraint on |Sᵢ| simplifies to |Sᵢ|=|ISᵢ|−tₒ(i)·Rᵢ. These constraints on Sᵢ enable to determine any Lᵢ=ISᵢ−Sᵢ, and to thereby determine a set of locations Lᵢ which can be expected to be fused by the i^{th}-beam source almost exactly within the preselected optimum fusing time tₒ(i). Thus, if all sets of locations {Lᵢ} are, e.g., iteratively determined as explained above these are be selected such that the time for fusing the area may be minimized. This minimization is due to the fact the suggested determination of the sets of locations {Lᵢ} ensures, that within the error margins given by the β_{t,i} and αᵢ it can be expected that all beam sources require the same amount of time to fuse their respective set of locations Lᵢ. Idling of beam sources is minimized. It should be noted that it is not required to determine all Lᵢ as suggested. For example the n^{th} set of locations Lₙ can be determined using Lₙ=A−Σᵢ₌₁ⁿ⁻¹Lᵢ because A=Σᵢ₌₁ⁿLᵢ.

Herein, we assume that the steps are reiterated for every i≤n, starting with the lowest value of i=1 and then within each iteration the value is increased by one, i.e. prior to each repetition of step 1.1 or 1.2, i:=i+1 is executed, but this is only for conceptual simplicity, as Lₙ=A−Σᵢ₌₁ⁿ⁻¹Lᵢ. Hence, it is sufficient to execute the steps only n−1 times and still obtain the same result. The condition ∀\vec{p}ᵢ∈Sᵢ, ∃Fₖ|\vec{p}ᵢ∈Fₖ, k>i is based on the assumption that the subtrahend surfaces Sᵢ are determined in ascending order, i.e. that i increases by one after a subtrahend surface Sᵢ has been determined for particular i. This sequence is not necessary, but if it is released the condition “k>i” would read “wherein i may take any value for which a subtrahend surface Sₖ has not yet been determined”. Both wordings are equivalent, as by renumbering the beam sources the same sequence of determining the subtrahend surfaces Sᵢ can be obtained, while taking care that the index i steadly increases by 1 after a particular subtrahend surface has been determined.

Of course, the method can be repeated for each layer and hence the time for manufacturing a workpiece is minimized. For a given powder bed fusing apparatus, the cost for manufacturing the workpiece is reduced.

To reiterate it vividly, the subtrahend surfaces Sᵢ are thus subsets of vectors of the area A, being selected such that the expected time <tᵢ> for irradiating the surface given by the set of locations Lᵢ:=ISᵢ−S_{I} equals the optimum fusing time tₒ(i) with an accuracy being given by the selection of αᵢ, β_{t,i}. Assuming that tₒ(i)·Rᵢ<|ISᵢ| is true for all i and α=0 as well as β_{t,i}=0 then <tᵢ>=tₒ(i)∀i, i.e. the total time tₜₒₜ being required to fuse the area A using the n beam sources simultaneously is tₜₒₜ=Max(tₒ(i)) and identical to the lower limit being inherent to the apparatus and the material to be fused. At this point it should be recalled that in practical applications, a workpiece may have thousands of layers, and thus small savings in irradiating an area on each layer accumulate to non-negligible cost savings.

Once Sᵢ has been determined for a given i, the i^{th}-set of locations Lᵢ can be determined using Lᵢ:=ISᵢ−Sᵢ (step 1.3.2) and the method may proceed with fusing the corresponding set of locations of Lᵢ using the i^{th}-beam source (step 1.4). Before continuing to execute step 1.4, preferably at least the steps 1.2 to 1.3.2 are repeated for each other beam source, i.e. for all remaining beam sources (1<i≤n). Step 1.4 may be preferably executed for at least two different Lᵢ, Lⱼ, (i≠j) at the same time. The higher the number of beams that are irradiating their correspondingly assigned surfaces Lᵢ simultaneously the better. Preferably, all n beam sources irradiate at the same time.

In case the size of a section Lᵢ is below a given threshold, e.g. below the threshold Tᵢ explained above, the section Lᵢ may be set to zero (Lᵢ:={}), which is equivalent to reducing the number of beam sources to n−1, i.e. an i^{th}-beam source may be removed from the pool of n beam sources, if |Lᵢ|<Tᵢ.

There may be cases in which the overlap between the area A and a field of view Fᵢ is so small that the time required to irradiate the corresponding interesting set ISᵢ=A∩Fᵢ is smaller than the optimum time tₒ(i), in this case tₒ·Rᵢ>|ISᵢ| is true. In this case one could simply assign Lᵢ:=ISᵢ, but in practice it may be necessary to have a defined shape of Lᵢ or that Lᵢ does not extend in predefined sectors of the area A. Thus, more generally, a subtrahend surface Sᵢ is defined with Sᵢ⊂ISᵢ under the condition that for each \vec{p}ᵢ∈Sᵢ, ∃Fₖ|\vec{p}ᵢ∈Fₖ, k>i. Further, in the case of tₒ·Rᵢ>|ISᵢ| then |Sᵢ| may preferably be minimized. Once Sᵢ hast been determined, the set of locations Lᵢ to be irradiated by the i^{th}-beam source is determined using Lᵢ:=ISᵢ−Sᵢ, i.e. the method may continue to step 1.4.

The condition “for each \vec{p}ᵢ∈Sᵢ, ∃Fₖ|\vec{p}ᵢ∈Fₖ, k>i” reads in plain language that for each vector \vec{p}ᵢ which vector \vec{p}ᵢ is an element of the subtrahend surface Sᵢ exists at least one field of view Fₖ such that the field of view Fₖ includes the vector \vec{p}ᵢ, wherein the index k is larger than the index i. This condition ensures that any point/location of the area A being removed from the intersecting set ISᵢ can be irradiated by at least one other beam source for which the set of locations Lₖ has not yet been determined, the latter following from k>i. Any location of the area A which can be fused by only by a limited number of beam sources forming a set of indices X may thus be assigned at latest to a set of locations L_{Max(X)} with the highest index of said set X.

The corresponding expectation value of the time for irradiating the surface of the layer with the i^{th}-beam source reads identically to the other case <tᵢ>=Lᵢ/Rᵢ. Generalizing, one may say that in case tₒ·R≥|ISᵢ|,i.e. in the “ELSE” case of step 1.3 (i.e. if (tₒ·Rᵢ≥|ISᵢ|), steps 1.3.1 and 1.3.2 may be executed while the condition (1−αᵢ)·(|ISᵢ|−tₒ·Rᵢ)≤|Sᵢ|≤(1+αᵢ)·(|ISᵢ|−tₒ·Rᵢ) may be released.

Preferably, particularly in case tₒ·Rᵢ≥|ISᵢ| (but generally in any case), a corrected minimum time tₒ(i+1), as well referred to as t′ₒ may be calculated in a subsequent iteration of step 1.1 (i.e. after setting i:=i+1) using e.g.

$${t}_{o} ( i ) := {t}_{o} ( i - 1 ) + \frac{( {t}_{o} - < {t}_{i - 1} > ) \cdot {R}_{i - 1}}{{\sum }_{j = i}^{j \leq n} {R}_{j}} .$$

The corrected minimum time may then be used in future executions of steps 1.3 to 1.3.2 and instead of an initially calculated or estimated optimum fusing time. This adjustment of the optimum time tₒ(i) enhances an even load distribution between the beam sources for which the set of locations has not yet been determined, i.e. the variation of |Lⱼ| (i<j≤n) is reduced. This provides a further increase in efficient use of the apparatus' capabilities and hence translates in lower manufacturing costs of a corresponding workpiece.

The step of calculating a corrected minimum time can be generalized by recalculating a (corrected) minimum optimal time with each iteration, i.e. in step 1.1 tₒ(i) may be

$${t}_{o} ( 1 ) = ( 1 \pm {β}_{t} ( i ) ) \frac{\vert A \vert}{{\sum }_{j}^{n} {R}_{j}}$$

$${t}_{o} ( i ) = ( 1 \pm {β}_{t , i} ) \cdot ( {t}_{o} ( i - 1 ) + \frac{{t}_{o ( i - 1 )} \cdot {R}_{i - 1} - \vert {L}_{i - 1} \vert}{{\sum }_{j = i}^{n} {R}_{j}} ) ∀ 2 \leq i \leq n ,$$

being equivalent to

$${t}_{o} ( i ) = ( 1 \pm {β}_{t , i} ) \frac{\vert A \vert - {\sum }_{j = 1}^{i - 1} \vert {L}_{j} \vert}{{\sum }_{j = i}^{n} {R}_{j}}$$

wherein if i=0 the term Σⱼ₌₁ⁱ⁻¹|Lⱼ|:=0 and hence

$${t}_{o} ( 1 ) = ( 1 \pm {β}_{t , i} ) \frac{\vert A \vert}{{\sum }_{j = i}^{n} {R}_{j}} .$$

Again, the preferred case may be βₜ(i)=0 and i indicates the i^{th}-execution of the steps. As already apparent, β_{t,i} as defined above serves as an error margin and tₒ(i) may be selected to be within boundaries being given by selection either the “+” or the “−” of “±”. Generally, β_{t,1}=βₜ(i) can be different for every iteration only for simplicity we will write βₜ as well. The of step calculating a corrected minimum time may be particularly useful if the effects of non-negligible αᵢ sum up. In short both possibilities account for a potential difference between the optimum mean fusing time tₒ and the actually expected fusing times <tᵢ>=|Lᵢ|/Rᵢ for each iteration of the calculation of Lᵢ. If not addressed, these differences may lead to the situation that |Lₙ| may be significantly bigger that all other Lⱼ, (1≤j<n), and hence significant idle times of the beam sources 1 to n−1 reduce the efficiency of the additive manufacturing process. Thus, again the step of recalculating an updated optimum mean fusing time further contributes to reducing the operating costs per workpiece.

In case the size of a section Lᵢ is below a given threshold, e.g. below the threshold Tᵢ explained above, the section Lᵢ may be set to zero (Lᵢ:={}), which is equivalent to reducing the number of beam sources to n−1, i.e. an i^{th}-beam source may be removed from the pool of n beam sources, if |Lᵢ|<Tᵢ. Of course, in this case it may be preferred to calculate a corrected minimum time and/or a corrected optimum size of a corresponding fusing area |Lᵢ^{opt}|.

The threshold Tᵢ may be defined for each i^{th}-beam source individually. It may as well be set manually for each beam source individually or for all or a number of beam sources, e.g. based on the experience of an operator. In a preferred example, the threshold Tᵢ may be a set portion of the optimum size of the fusing area |Lᵢ^{opt}|, e.g. Tᵢ=c_{T}_{ᵢ}·|Lᵢ^{opt}|, wherein

c_{T}_{ᵢ}∈{0.95, 0.9, 0.8, 0.7, 0.6, 0.5, 0.4, 0.3, 0.2, 0.1, 0.05}.

Preferably, the method may further include to define at least a first (preferably meandering) line B_{i,j} and preferably as well a second (preferably meandering) line B_{i,k}, wherein the first (preferably meandering) line B_{i,j} extends (preferably meanders) in a first direction \vec{b}₁ and the second (preferably meandering) line B_{i,k} extends (preferably meanders) in a second direction \vec{b}₂ (step 4.1). The first (preferably meandering) line may be used to limit the extension the subtrahend surface Sᵢ in a direction being at least essentially orthogonal to the first direction \vec{b}₁. Similarly, the second (preferably meandering) line may be used to limit the extension the subtrahend surface Sᵢ in a direction being at least essentially orthogonal to the second direction \vec{b}₂. At least one of the first and second (preferably meandering) lines hence determines a first boundary of the subtrahend surface Sᵢ (step 4.2). At least one of these first and second (preferably meandering) lines may be shifted to reduce ΔSᵢ, wherein ΔSᵢ=|tₒ(i)·Rᵢ−|ISᵢ−Sᵢ|. Further preferably, when determining an Sⱼ after another Sᵢ (i.e. i<j) and if the i^{th}-beam source and the j^{th}-beam source are neighbours (or at least have overlapping fields of view), then B_{j,i}=B_{i,j}.

During this shifting, the first (preferably meandering) line B_{i,j} may preferably be shifted at least essentially orthogonal to the first direction \vec{b}₁ and/or the second (preferably meandering) line may preferably be shifted at least essentially orthogonal to the second direction \vec{b}₂ to reduce ΔSᵢ, preferably until the condition 1.3.1 is met. As already apparent the two vectors \vec{b}₁, \vec{b}₂ are preferably linearly independent (condition 5), and particularly preferred they may be at least essentially orthogonal to each other, i.e. preferably \vec{b}₁⊥\vec{b}₂. Exceptionally the indices of the vectors \vec{b}₁, \vec{b}₂, . . . are not associated with a beam source, these serve only to distinguish these vectors. The indices of the lines B_{i,j} however are preferably associated to two beam sources, namely to the i^{th}- and to the j^{th}-beam source, after determining all Lᵢ, the (preferably meandering) line B_{i,j} separates the sets of locations Lᵢ and Lⱼ.

A line B_{i,j} meanders along or in the direction \vec{b}₁ if the line B_{i,j} has a first end point \vec{b}_{i,j,e} that obeys the condition |\vec{b}₁·(\vec{b}_{i,j,l}−\vec{b}_{i,j,e})|≠|\vec{b}₁·(\vec{b}_{i,j,m}−\vec{b}_{i,j,e})|∀\vec{b}_{i,j,l},\vec{b}_{i,j,m}∈B_{i,j},\vec{b}_{i,j,l}≠\vec{b}_{i,j,m} and if |\vec{b}_{⊥}·(\vec{b}_{i,j,l}−\vec{b}_{i,j,e})≠|\vec{b}_{⊥·(\vec{b}}_{i,j,m}−\vec{b}_{i,j,e})|∀\vec{b}_{i,j,l},\vec{b}_{i,j,m}∈B_{i,j},\vec{b}_{i,j,l}≠\vec{b}_{i,j,m} with \vec{b}_{⊥}⊥\vec{b}₁ does not hold true.

Fusing the fusible material at the set of locations Lᵢ may include pivoting the i^{th}-beam source while the i^{th}-beam source projects an i^{th}-beam spot to thereby move the i^{th}-beam spot along lines being multiples of a vector \vec{v}ᵢ. In a preferred example, the meandering lines include or consist of concatenated sections being, in alternating sequence, perpendicular to \vec{v}ᵢ or parallel to \vec{v}ᵢ (step 6).

Particularly preferred, the method further includes to execute the steps 1.2 and 1.3 (and optionally of course as well all other steps) first for the beam source that has a field of view which has the least overlap with the fields of view of other beam sources. Next, the steps are executed for the beam source which field of view has the second least overlap with other fields of view and so. This helps to reduce the computational effort when calculating the corresponding subtrahend surfaces Sᵢ, as in this way first those portions of the area are assigned to a set of locations Lᵢ that in the worst case can be irradiated only by a single beam source, which may—if not accounted for—yield to the situation that a single beam source operates much longer than the others. Executing the steps 1.2 and 1.3 (and optionally of course as any of the other steps) first for the beam source that has a field of view which has the least overlap with the fields of view of other beam sources and so on may be obtained by sorting the indices of the beam sources such that the first (i=1) beam source has the field of view F₁ that has the least overlap and second (i=2) beam source has the field of view F₂ with the second least overlap and so forth. In other words, this means that preferably initially, but at latest prior to step 1.2 the indices of the fields of view Fᵢ are preferably sorted to obey the condition

Min(Σⱼ^{i≠j}Fᵢ∩Fⱼ)≤Min(Σⱼ^{i+1≠j}Fᵢ₊ₙ∩Fⱼ)∀i<n and that at least the steps 1.2 and 1.3 are repeated while increasing the value of the index with each repetition by one until the index i=n. Of course, for those Fᵢ for which Fᵢ∩A={} sorting can be omitted as it is clear that the corresponding set of locations Lᵢ is empty, i.e. Lᵢ={}.

In addition or alternatively, the method may include (as well prior to step 1.2), sorting the indices of the fields of view Fᵢ to obey the condition |Fᵢ∩A|≤|Fⱼ∩A|∀i<j and that steps 1.2 and 1.3 and optionally at least one of the steps REF _Ref65147212\r\h\* MERGEFORMAT 2.1 to 2.3 are repeated while increasing the value of the index with each repetition by one. Again, the position of the beam sources having an index i for which Fᵢ∩A={} can be selected arbitrarily. As well, this sorting step cases determining the subtrahend surfaces Sᵢ, while maintaining the error margin αᵢ small, i.e. to reduce avoidable idle times of beam sources that generally could contribute to fusing the area A.

The method may further include, prior to determining a subtrahend surface Sᵢ to assigning a portion Cᵢ of the area A to a dedicated i^{th}-beam source. In practice the beam sources are calibrated to operate all in the same coordinate system. This calibration, however, is not perfect and can deteriorate during the process of manufacturing. When assigning particular portions Cᵢ of the area A a priori to a certain dedicated i^{th}-beam source, imperfections of the workpiece can be reduced in this portion Cᵢ, thus Cᵢ⊂Fᵢ, i.e. the portion Cᵢ is within the field of view Fᵢ. Normally, such an assignment increases the total manufacturing time, because the load distribution between the different beam-sources is deteriorated. In an embodiment, this deterioration can be avoided by considering the additional constraint Sᵢ∩Cᵢ={} when determining the subtrahend surface Sᵢ, e.g. in steps 1.3.1 and/or 2.1. Obeying the additional constraint Sᵢ∩Cᵢ={} ensures, that the portion Cᵢ is a subset of the subsequently determined set of locations Lᵢ being later irradiated by the i^{th}-beam source, and that the additional size of the set of locations Lᵢ being due to the portion Cᵢ is considered in the load balancing constraint

$$( 1 - {α}_{i} ) \cdot ( \vert {IS}_{i} \vert - \cdot {t}_{o} \cdot {R}_{i} ) \leq \vert {S}_{i} \vert \leq ( 1 + {α}_{i} ) \cdot ( \vert {IS}_{i} \vert - \cdot {t}_{o} \cdot {R}_{i} ) of steps 1.3 \text{.1} .$$

In an embodiment, when repeating step 1.2, the intersecting sets ISⱼ (j≥2) are determined as ISⱼ:=(A−Σᵢ₌₁^{i<j}Lᵢ)∩Fⱼ. This step provides a number of advantages: The memory requirements are reduced and further determining a suited subtrahend surface Sᵢ is significantly simplified, leading to further cost optimizations. The idea underlying this improvement is that those portions of the field of view Fᵢ that already have been assigned to sets of locations Lᵢ, (i<j) in previous executions i of at least one of the steps 1.2 to 1.3.2 and/or 1.2 to 2.3 do not need to be included in further considerations. As Σᵢ₌₁^{1<0}Lᵢ=0, the condition j≥2 can be released, i.e. ISⱼ may be defined as ISⱼ:=(A−Σᵢ₌₁^{i<j}Lᵢ)∩Fⱼ∀j∈I∀j∈I

During the fusing process, i.e. during operation of the beam sources it may be preferred to establish an inert gas flow over the top of the powder bed to thereby remove fumes and other residues out of the fields of view Fᵢ. Preferably, a flow in a flow direction parallel to the top surface of the layer may be established, e.g. by arranging at least one inlet nozzle at a first side of the top layer and at least one outlet nozzle at the opposite side of the top layer and by establishing an inert gas flow from the inlet nozzle to the outlet nozzle, thereby defining a main flow direction. In other words, the method may further include establishing an inert gas flow in a flow direction \vec{d} over the top of the powder bed, wherein \vec{d}ₕ denotes the (preferably normalized) component of the flow direction being parallel to the layer of fusible material, i.e. the projection of the flow direction \vec{d} onto the area A. For example, if the z-axis is perpendicular to the surface of the layer of fusible material (and hence to the area A), then using cartesian coordinates

$${\vec{d}}_{h} = {( {d}_{x}^{2} + {d}_{y}^{2} )}^{- \frac{1}{2}} {( {d}_{x} , {d}_{y} , 0 )}^{T} ,$$

wherein (dₓ²+d_{y}²)^{-1/2} is only a normalization factor setting |\vec{d}ₕ|=1, and can be omitted. As usual dₓ, d_{y} and d_{z} are the x-, y- and z-components of the vector \vec{d}, respectively.

This flow direction parallel to the layer \vec{d}ₕ may preferably be correlated with the extension of the meandering lines B_{i,j} limiting the subtrahend surfaces Sᵢ and which define the boundary between adjacent sets of locations Lᵢ and Lⱼ such that the boundary B_{i,j} between two sets of locations Lᵢ and Lⱼ has a first end point \vec{b}_{i,j,e} that obeys the condition |\vec{d}ₕ·(\vec{b}_{i,j,l}−\vec{b}_{i,j,e})|≠|\vec{d}ₕ·(\vec{b}_{i,j,m}−\vec{b}_{i,j,e})|∀\vec{b}_{i,j,l},\vec{b}_{i,j,l}≠\vec{b}_{i,j,m} (condition 13.1). This means that any distance between the first end point \vec{b}_{i,j,e} and any other point \vec{b}_{i,j,l} of the boundary B_{i,j} exists only once. Hence, any subsection of B_{i,j} has a non-vanishing extension in the direction defined by the horizontal component of the flow direction \vec{d}ₕ. In this case the relation |\vec{d}ₒ·(\vec{b}_{i,j,l}−\vec{b}_{i,j,e})≠|\vec{d}ₒ·(\vec{b}_{i,j,m}−\vec{q}ₑ)|∀\vec{b}_{i,j,l},\vec{b}_{i,j,m}∈Bᵢ,\vec{b}_{i,j,l}≠\vec{b}_{i,j,m} (condition 13.2) with \vec{d}ₒ⊥\vec{d}ₕ dn is preferably not realized, thus B_{i,j} is not a straight line but may meander essentially parallel to the horizontal component of the flow direction \vec{d}ₕ.

Alternatively, the boundary B_{i,j} may meander orthogonal to the horizontal component of the flow direction \vec{d}ₕ. In this case the relation |\vec{d}ₒ·(\vec{b}_{i,j,l}−\vec{b}_{i,j,e})|≠|\vec{d}ₒ·(\vec{b}_{i,j,m}−\vec{q}ₑ)|∀\vec{b}_{i,j,l},\vec{b}_{i,j,m}∈Bᵢ,\vec{b}_{i,j,l}≠\vec{b}_{i,j,m}, wherein \vec{d}ₒ⊥\vec{d}ₕ is obeyed, while condition |\vec{d}ₕ·(\vec{b}_{i,j,l}−\vec{b}_{i,j,e})|≠|\vec{d}ₕ·(\vec{b}_{i,j,m}−\vec{q}ₑ)|∀\vec{b}_{i,j,l},\vec{b}_{i,j,m}∈Bᵢ,\vec{b}_{i,j,l}≠\vec{b}_{i,j,m} (condition 13.1) may preferably not be realized.

These measures being referenced to as conditions 13.1 and 13.2 each vastly simplify to coordinate the movement of the n beam spots over the layer such that at any moment in time no beam spot is below fume that has been generated by another beam spot, while operating the beam sources simultaneously.

As stated above, the beam sources may be pivoted while irradiating the surface to thereby project beam spots onto the layer. Thus, preferably each beam spot may be moved over the surface of the layer and thereby fuses the fusible material at the locations \vec{l}ᵢ of the respective set of locations Lᵢ. In other words, fusing the fusable material at the set of locations Lᵢ includes pivoting the i^{th} beam source while the i^{th}-beam source projects the i^{th}-beam onto the area A to thereby move the i^{th}-beam spot. Preferably the movement of the i^{th}-beam spot can be described by a multiple of a vector \vec{v}ᵢ having a component being opposite to the flow direction \vec{d}ₕ of the inert gas flow. The beam spot so to speak moves towards the gas inlet and hence the fusing process is less affected by fumes previously produces by said beam spot. Subsequently, the beam source may be switched off and repositioned to continue irradiating another subset of Lᵢ while moving again in the direction being defined by \vec{v}ᵢ. The quality of the workpiece to be manufactures is increased accordingly.

For example, there may be at least two different meandering lines B_{i,j}, B_{q,r}, which are the boundaries between adjacent sets of locations Lᵢ, Lⱼ and L_{q}, Lᵣ, respectively. Preferably, an end point of the first section B_{i,j} may as well be an end point of the first section B_{q,r}. This measure aligns the corresponding sets of locations Lᵢ, Lⱼ, L_{q} and Lᵣ, preferably parallel and orthogonal to the flow direction \vec{d}ₕ being parallel to the layer. The latter can be obtained when, including the constraint on Sᵢ that condition 13.1 or 13.2 applies to both, B_{i,j} and B_{q,r}. Thereby the computational effort of the method can be further reduced and idle times to avoid beam spots at locations of fume being produced by other beam spots can be reduced. Thus, the quality of the workpiece can be enhanced while at the same time manufacturing cost for a workpiece are reduced.

For example, if condition 13.1 applies to both, B_{i,j} and B_{q,r}, the sets of locations Lᵢ, Lⱼ, L_{q} and Lᵣ, may be separated into m portions L_{s,1}, L_{s,2}, . . . , L_{s,m},, (m≥2) by lines meandering parallel to \vec{d}ₕ and wherein |L_{s,l}|=|L_{s,n}|±0.15·|L_{s,n}|∀s∈{i, j, q, r}, l, n≤m, l≠n, (the factor 0.15 can be replaced by any other value of {0.1, 0.05, 0.025, 0.1, 0.005}) wherein portions with the same second index are aligned parallel to \vec{d}ₕ and in that only portions with the same second index are irradiated simultaneously. This provides for a very effective and simple measure to avoid that fumes being produces by any beam spot affects fusing of the fusible material by another beam spot. An increase of the number of portions enables to increase the minimum distance between two beam spots measured perpendicular to the vector \vec{d}ₕ. Meandering parallel or orthogonal to \vec{d}ₕ means that the distance measured parallel, or orthogonal, respectively, to \vec{d}ₕ between an end point of the respective line and any other point of said line is unique (condition 13.1 or 13.2, respectively, applies to said line).

Preferably, the forming region that has area A may be separated (divided) into at least 2n stripes or sub-regions (generally into c·n stripes, wherein c is an integer with c≥2) extending at least essentially parallel to the horizontal component \vec{d}ₕ of the inert gas flow. Preferably, during fusing only locations Lᵢ in every second stripe are fused at the same time. Thus, in between of two beam spots may be at least a distance corresponding to the width of the corresponding stripe. This results and thus implies a scanning with beam source(s) of at least c·n stripes. By choosing the width of the stripes, one can avoid that any beam spot fuses at a location with a significant concentration of fumes which has been produced by another beam spot. Thus, between two stripes being irradiated or fused simultaneously, there are c−1 stripes which are not irradiated and their width may be the minimum distance by which two beam spots are separated. This allows to initially radiate a first set of the stripes and subsequently a second set of the stripes until the forming region having area A is irradiated. As already apparent, the boundaries of at least some of the stripes are preferably given by the meandering lines as explained above.

Only to avoid any misunderstanding, we recall that as usual the layer is the top layer of a powder bed. Further, herein, as usual “{}” symbolizes an empty set. Herein we use as well the number “0” to express that a set is empty, i.e. if a set V is empty is can be expressed as V={} as well as V=0.

Herein at “least essentially perpendicular” or “least essentially orthogonal” expressed, that an angle of 90° is preferred, but that deviations may be accepted, the angle may thus be within 90°±45°, 90°±30°, 90°±15°, 90°±10°, 90°±5°, 90°±2.5°, 90°±1° or 90°±0°. Similarly, “least essentially parallel” allows for deviations from perfect parallel alignment, i.e. angles be within 0°±45°, 0°±30°, 0°±15°, 0°±10°, 0°±5°, 0°±2.5°,° ±1° or 0°±0° may be selected as well, wherein exactly parallel) (±0°) is preferred. Further, two meandering lines meandering in the directions being given by vectors \vec{b}₁ and \vec{b}₂ are considered to be perpendicular or parallel, if these vectors \vec{b}₁ and \vec{b}₂ are perpendicular or parallel, respectively.

### BRIEF DESCRIPTION OF THE DRAWINGS

In the following, the invention will be described by way of example, without limitation of the general inventive concept, on examples of embodiment and with reference to the drawings.

FIG. 1 shows an additive manufacturing apparatus,

FIG. 2 shows a top view of the up facing surface of a powder bed,

FIG. 3 shows detail D₁ of FIG. 2.

FIG. 4 shows detail D₁₁ of FIG. 2.

FIG. 5 shows a flow diagram of a method for determining sets of locations Lᵢ.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

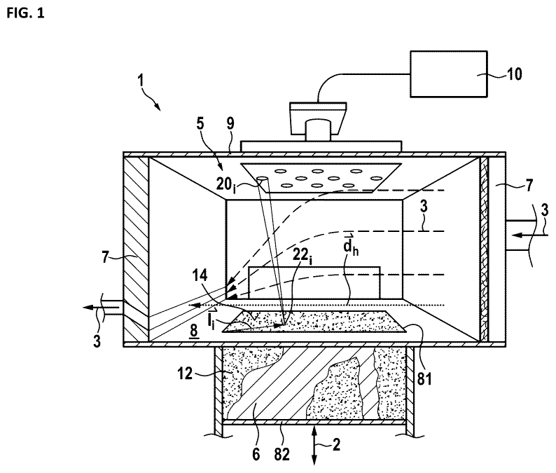

In FIG. 1 a first embodiment is shown. The additive manufacturing apparatus 1, is shown in a sectional view and has a process chamber 5, being enclosed by sidewalls 7, a bottom 8 and a ceiling 9. In the bottom is an opening 81. Below the opening may be a movably supported support 82 as indicated by the double headed arrow 2. On the top of the support may be a powder bed 12 having a top layer with a surface 14. As sketched, a portion of a workpiece 6 may be embedded in the powder bed 12.

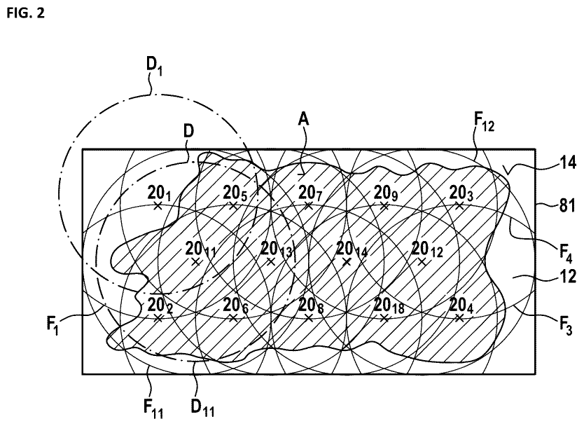

The surface 14 of the powder bed in FIG. 1 can be irradiated by beam spots 22ᵢ being projected by n beam sources 20ᵢ. Depicted is a number of n=8 beam sources 20ᵢ but this is only a preferred example, any other number n≥2 could have been chosen as well. For example, in FIG. 2 The powder particles of the powder bed 12 at locations \vec{l}ᵢ that are irradiated are by the i^{th}-beam spot 22ᵢ being emitted by the i^{th}-beam source 20ᵢ are fused together. In FIG. 1 only a single beam spot 22ᵢ and a single location \vec{l}ᵢ are indicated for simplicity, in practice, however, it is preferred if at least two beam spots 22, e.g., at least three, at least four or at least five beam spots 22ᵢ are emitted at the same time. Preferably all n beam sources 20ᵢ may each emit a beam spot 22ᵢ to a location \vec{l}ᵢ (i.e. 1≤i≤n) at the same time. The beam-sources 20ᵢ may be pivoted, hence the beam spots 22ᵢ may be moved over the surface 14 and each beam source 20ᵢ may irradiate a set of locations Lᵢ={\vec{l}ᵢ}, wherein the index i indicates the corresponding beam source 20ᵢ of the n beam sources. Once all sets of locations Lᵢ have been irradiated an area A=Σᵢ₌₁ⁿLᵢ has been irradiated (see FIG. 2). The area A may thus be a top surface of the corresponding layer of the workpiece 6 or at least a portion thereof. Once the area A has been irradiated, the support may be lowered by the thickness of a powder layer and a new powder layer may be applied, e.g. using a so called recoater, travelling over the opening 81. Subsequently, the next surface 14 of the new upmost layer of the powder bed 12 may be irradiated using the beam sources 20ᵢ.

During fusing of the powder bed's surface 14 fumes occur at the locations \vec{l}ᵢ of the surface. These fumes may be removed from the process chamber by establishing an inert gas flow 3 above and over the surface 14 of the powder bed 12 being symbolized by dashed arrows 3. The dashed arrows 3 each have common projection on the bottom 8, being symbolized the dotted arrow \vec{d}ₕ. The vector \vec{d}ₕ is thus the direction of the horizontal component of the inert gas flow 3 above and over the surface 14. In other words, the inert gas flow 3 has a component \vec{d}ₕ being parallel to the support's up facing surface.

A programmable electronic circuitry 10, briefly referred to as controller 10, controls at least a number of the beam sources 20ᵢ. Preferably as well at least one of the inert gas flow 3, a recoater and the movement of the support 82 may be controlled by the controller 10.

FIG. 2 shows a top view of a surface 14 of a layer of a powder bed 12. Each cross 20₁ to 20₁₄ represents the position of a beam source 20ᵢ (i.e. n=14 in this example) above the surface 14. Or in other words, the position of the crosses 20 can be obtained by a projection of the beam sources 20 onto the surface 14. Only to enable to reference to particular beam source 20, we added a subscript to each cross, i.e. 20₁, 20₄, indicate the cross representing the projection of the first beam source and of the fourth beam source, respectively. Generally, 20ᵢ, (1≤i≤n) denotes the cross representing the i^{th}-beam source. Further, as already stated with respect to FIG. 1, the present choice of n=14 is only an example. The only condition on the number n of beam sources is that n≥2.

Each beam source20ᵢ can irradiate a certain portion Fᵢ of the surface 14. These surfaces F₁, . . . , F₁₄ are referred to as fields of view Fᵢ. FIG. 2 further shows an example area A. The embodiments enable to assign portions of the area A to the different beam sources and subsequently to fuse the powder in area A while operating a maximum amount of beam sources at the same time. Idle times of beam sources 20 are reduced. The area A can be calculated based on a CAD-model of the workpiece 5, wherein “CAD” stands for “Computer Aided Design” and a CAD-Model is hence a description of the workpiece enabling to manufacture it.

As already explained above, the beam sources are labelled with indices or in any other appropriate manner, that enables to distinguish two of them. Herein we assume that the sets of locations Lᵢ to be irradiated by the i^{th}-beam source 20ᵢ are determined in an ascending order, starting with the first beam source 20₁. This ascending order is not required, but simplifies to explain and understand the invention. Accordingly, the last set of locations L₁₄ is already defined if all other 13 sets have been determined, as it is the not yet assigned portion of the area A to be fused, i.e. L₁₄=A−Σᵢ₌₁¹³Lᵢ or for any number n of beam sources Lₙ=A−Σᵢ₌₁ⁿ⁻¹Lᵢ.

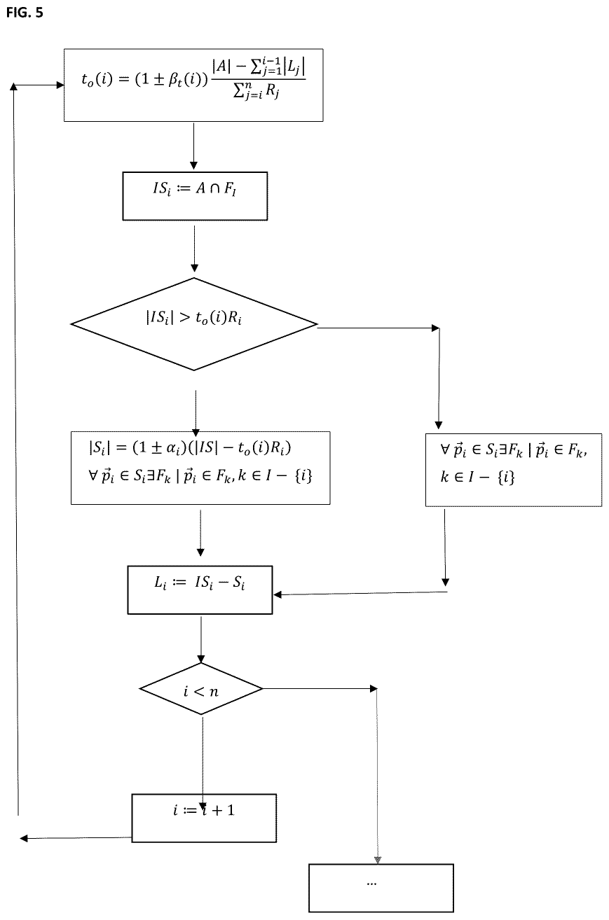

Once the beam sources 20ᵢ are labelled and the area A to be irradiated has been determined intersecting sets ISᵢ of the fields of view Fᵢ with the area A may be determined, generally ISᵢ=Fᵢ∩A, as depicted in FIG. 5. The method may thus include at least determining IS₁:=F₁∩A. Further an optimum fusing time tₒ(1) may be determined. This may take place prior or after the step of determining IS₁. This optimum fusing time tₒ(i) can be considered as an estimate of the time being required to fuse a subsequently determined portion Lᵢ of the area A. In other words, the size of the set of locations |Lᵢ| may be determined such that it may be expected that the set of locations Lᵢ can be fused by the i^{th}-beam source 20ᵢ within the optimum fusing time tₒ(i).

Preferably, the actual fusing times t_{α}(i) are all the same and in this case the optimum fusing time of the first beam source can be estimated as tₒ(1)=|A|/Σᵢ₌₁ⁿRᵢ, wherein the values Rᵢ are the fusing rate of the i^{th}-beam source (see FIG. 5). As usual, the fusing rate Rᵢ of the i^{th}-beam source is the quotient of the size of a test surface T and the time tₜ(i) required to fuse said test surface, i.e

$${R}_{i} = \frac{\vert T \vert}{{t}_{t} ( i )} .$$

This example of determining tₒ(1) is not the only valid choice for tₒ(i). Generally any value of tₒ(i) being withing

$$\frac{( 1 \pm {β}_{t , i} ) \vert A \vert}{{\sum }_{i = 1}^{n} {R}_{i}} ( i . e . {t}_{o} ( i ) = \frac{( 1 \pm {β}_{t , i} ) \vert A \vert}{{\sum }_{i = 1}^{n} {R}_{i}} )$$

may be considered reasonable, generally

$$\frac{( 1 - {β}_{t , i} ) \vert A \vert}{{\sum }_{i = 1}^{n} {R}_{i}} \leq {t}_{o} ( i ) \leq \frac{( 1 \pm {β}_{t , i} ) \vert A \vert}{{\sum }_{i = 1}^{n} {R}_{i}}$$

can be considered as a reasonable range for the margin, e.g. β_{t,i}∈B, with B={0.25, 0.2, 0.15, 0.1, 0.05, 0.025, 0.0125, 0.01, 0.005, 0.001}. Smaller values of β_{t,i} are preferred, particularly preferred may be β_{t,i}=0.

If tₒ(1) has been determined, the method may proceed to determining the first subtrahend surface S₁ (see FIG. 5). The first subtrahend surface S₁ may be a subset of the first intersecting set IS₁, i.e. S₁⊂IS₁ and as the name implies, subtracted from IS₁ to thereby determine the first set of locations L₁. When determining the first subtrahend surface S₁, only those points of the first intersecting set IS₁ can be considered which are as well included in other fields of view Fₖ, (k≠1). In more concise manner this can be expressed as ∀\vec{p}₁∈S₁, ∃Fₖ|\vec{p}₁∈Fₖ, k>1, reading that for all points \vec{p}₁ of the subtrahend surface S₁ exists a field of view Fₖ such that these points \vec{p}₁ are element of at least one field of view Fₖ, wherein k may take any integer value greater than 1. This condition ensures that points being removed (subtracted) from the intersection set IS₁ can be irradiated by another beam source. Further, the size of |S₁| may be adjusted to comply as good as reasonable with the constraint (1−α₁)·(|IS₁|−tₒ(1)·R₁)≤|S₁|≤(1+α₁)·(|IS₁|−tₒ(1)·R₁). This implies that |IS₁|≥(1−α₁)·tₒ(1)·R₁. As already explained above αᵢ∈{0.25, 0.2, 0.15, 0.1, 0.05, 0.025, 0.01, 0.005, 0}∀i. The smaller α₁ is selected the better, i.e. particularly preferred α₁=0. Once S₁ has been determined the first set of locations L₁ which is to be irradiated by the first beam source can be determined as L₁:=IS₁−S₁.

There may be cases in which the constraint (1−α₁)·(|IS₁|−tₒ(1)·R₁)≤|S₁|≤(1+α₁)·(|IS₁|−tₒ(1)·R₁) cannot be met, because the size of IS₁ may be smaller than (1−α₁)·tₒ(1)·R₁ (see FIG. 5). In this case one may select S₁:={}=0, but there may be other conditions to observe which may require to find a non-vanishing subtrahend surface S₁. This can be generalized into the following: If the constraint (1−αᵢ)·(|ISᵢ|−tₒ(i)·Rᵢ)≤|Sᵢ|≤(1+αᵢ)·(|ISᵢ|−tₒ(1)·Rᵢ) cannot be met, because the size of ISᵢ (i.e. |ISᵢ|) may be smaller than (1−αᵢ)·tₒ(i)·Rᵢ. In this case one may select Sᵢ:={}=0, but there may be other conditions to observe which may require or at least render it favourable to find a non-vanishing subtrahend surface Sᵢ. An example for choosing a non-vanishing subtrahend surface Sᵢ is the case when the boundary between neighboured surfaces Lᵢ, Lⱼ shall have a predefined shape.

As already explained above, it is preferred if the sets of locations Lᵢ have a size above a threshold Tᵢ i.e. if |Lᵢ|>Tᵢ. If this condition cannot be met, Sᵢ may be set to ISᵢ, i.e. Sᵢ:=ISᵢ being equivalent to removing the i^{th} beam source from the pool of available beam sources.

Subsequently, these steps may be repeated for the next beam source, which in this example may be the second beam source. Formally this can be described as repeating the steps after replacing the index 1 by 2 and by using tₒ(2) instead of tₒ(1) (see FIG. 5). Hence this repetition provides the second set of locations L₂. In a more general manner one my say that once an i^{th}-set of locations Lᵢ has been determined or at least could be determined because ISᵢ and Sᵢ are known, the method may be reiterated for all remaining beam sources or to say it differently i:=i+1 until i=n. In an explicit language this means that preferably a new optimum time tₒ(i) may be determined for every i∈I. Preferably the new optimum time takes into account any deviation of the time(s) that can be expected <tⱼ>, (j<i) to be required by the beam sources having a lower index. For example

$${t}_{o} ( i + 1 ) := {t}_{o} ( i ) + \frac{( {t}_{o} - < {t}_{i} > ) \cdot {R}_{i}}{{\sum }_{j = i + 1}^{j \leq n} {R}_{j}} ,$$

more generally and to allow small deviations from the suggested optimum value one may determine the updated optimum time to obey the constraint

$$( 1 - {β}_{t , i} ) ( {t}_{o} ( i - 1 ) + \frac{{t}_{o ( i - 1 )} \cdot {R}_{i - 1} - \vert {L}_{i - 1} \vert}{{\sum }_{j = i}^{n} {R}_{j}} ) \leq {t}_{o} ( i ) \leq ( 1 + {β}_{t , i} ) ( {t}_{o} ( i - 1 ) + \frac{{t}_{o ( i - 1 )} \cdot {R}_{i - 1} - \vert {L}_{i - 1} \vert}{{\sum }_{j = i}^{n} {R}_{j}} ) ∀ 2 \leq i \leq n ,$$

being equivalent to

$$( 1 - {β}_{t , i} ) \frac{\vert A \vert - {\sum }_{j = 1}^{i - 1} \vert {L}_{j} \vert}{{\sum }_{j = i}^{n} {R}_{j}} \leq {t}_{o} ( i ) \leq ( 1 + {β}_{t , i} ) \frac{\vert A \vert - {\sum }_{j = 1}^{i - 1} \vert {L}_{j} \vert}{{\sum }_{j = i}^{n} {R}_{j}}$$

or in short

$${t}_{o} ( i ) = ( 1 \pm {β}_{t , i} ) \frac{\vert A \vert - {\sum }_{j = 1}^{i - 1} \vert {L}_{j} \vert}{{\sum }_{j = i}^{n} {R}_{j}} ,$$

wherein if i=0 the term Σⱼ₌₁ⁱ⁻¹|Lⱼ|:=0 and hence

$${t}_{o} ( 1 ) = ( 1 \pm {β}_{t , i} ) \frac{\vert A \vert}{{\sum }_{j = i}^{n} {R}_{j}} .$$

Again, the preferred case may be β_{t,i}=0.

Next or as well prior to determining the updated optimum fusing time tₒ(i) the next intersecting set may be determined using ISᵢ:=Fᵢ∩A.

Once ISᵢ and tₒ(i) are determined, the method may proceed to the step of determining the corresponding subtrahend surface Sᵢ, wherein Sᵢ obey the condition ∀\vec{p}₁∈S₁, ∃Fₖ|\vec{p}₁∈Fₖ, k>i and if |ISᵢ|≥tₒ(i)·RᵢSᵢ further obeys (1−αᵢ)·(|ISᵢ|−tₒ(i)·Rᵢ)≤|Sᵢ|≤(1−αᵢ)·(|ISᵢ|−tₒ(i)·Rᵢ), and αᵢ∈{0.25, 0.2, 0.15, 0.1, 0.05, 0.025, 0.01, 0.005, 0}.

Once the ISᵢ and Sᵢ are determined, the method may proceed to define Lᵢ:=ISᵢ−Sᵢ, and to increase i by one (i:=i+1, unless i=n) and reiterate the process until n sets of locations Lᵢ, 1≤i≤n have been determined. As already apparent, the n^{th} set can as well be determined using Lₙ=A−Σᵢ₌₁ⁿ⁻¹Lᵢ. The controller may then control the beam sources 20ᵢ to project their respective beam spots 22ᵢ onto the corresponding sets of locations Lᵢ.

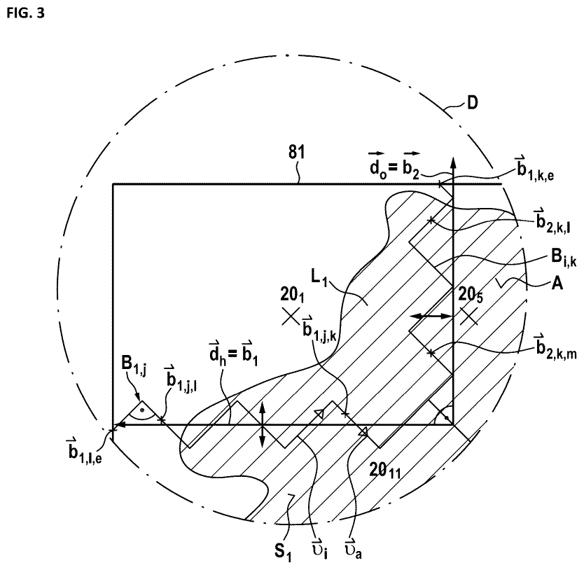

An example for determining a subtrahend surface Sᵢ is explained with respect to FIG. 3. FIG. 3 shows the detail D of FIG. 2 with some extra information: Determining a subtrahend surface Sᵢ may include to determine at least a first meandering line B_{i,j}. In the example of FIG. 3, there are two meandering lines, the first meandering B_{1,j} line extends parallel to flow direction \vec{d}ₕ and the second meandering line B_{1,k} extends perpendicular to \vec{d}ₕ, i.e. parallel to \vec{d}ₒ (thus \vec{d}ₒ⊥\vec{d}ₕ). As can be seen, the first meandering line has a first end point \vec{b}_{1,l,e}. The line B_{i,j} meanders a long or in the direction \vec{b}₁ because the line B_{1,j} as a first end point \vec{b}_{1,j,e} and any point \vec{b}_{1,j}, on the meandering line B_{1,j} has a unique distance to the first end point \vec{b}_{1,j,e}, thus the meandering line B_{1,j} obeys the condition |\vec{b}₁·(\vec{b}_{i,j,l}−\vec{b}_{i,j,e})|≠|\vec{b}₁(\vec{b}_{i,j,m}−\vec{b}_{i,j,e})|∀\vec{b}_{i,j,l},\vec{b}_{i,j,m}∈B_{i,j},\vec{b}_{i,j,l}≠\vec{b}_{i,j,m}, while in this example \vec{b}₁=\vec{d}ₕbeing a preferred choice. Further orthogonal to \vec{b}₁ the distances of the points of the meandering line B_{1,j} are not unique, i.e. |\vec{b}_{⊥}·(\vec{b}_{1,j,l}−\vec{b}_{1,j,e})|≠|\vec{b}_{⊥}·(\vec{b}_{1,j,m}−\vec{b}_{1,j,e})|∀\vec{b}_{1,j,l},\vec{b}_{1,j,m}∈B_{1,j},\vec{b}_{1,j,l}≠\vec{b}_{1,j,m} with \vec{b}_{⊥}⊥\vec{b}₁ does not hold true. In the depicted preferred example, the first meandering line B_{1,j} has straight sections which can be described as multiples of a fusing vector \vec{v}ᵢ, and further straight sections extending in an angle, preferably orthogonally, to the fusing vector \vec{v}ᵢ. The corresponding vector is hence indicated as \vec{v}ₐ The fusing vector \vec{v}ᵢ is a vector along which the i^{th}-beam spot may be moved over the surface while fusing the set of locations Lᵢ.

In the example of FIG. 3 there is an optional second meandering line B_{1,k} that meanders orthogonal to the first meandering line B_{1,j}. Thus |\vec{b}₂·(\vec{b}_{1,k,l}−\vec{b}_{1,k,e})|≠|\vec{b}₁·(\vec{b}_{i,k,m}−\vec{b}_{i,k,e})|∀\vec{b}_{i,k,l},\vec{b}_{i,k,m}∈B_{1,k},\vec{b}_{i,k,l}≠\vec{b}_{i,k,m}, while in this example \vec{b}₂=\vec{b}ₒ=\vec{b}_{⊥}. It is emphasised that this choice is only an example, other choices may be used as well. Preferably, \vec{b}₁ and \vec{b}₂ are linearly independent (i.e. \vec{b}₁≠c·\vec{b}₂∀c).

When determining the subtrahend surface S₁ (more generally Sᵢ) one may simply shift the meandering lines B_{1,j} and B_{1,k} (more generally B_{i,j} and B_{i,k}). In a preferred example embodiment, the corresponding meandering lines B_{i,j} and B_{i,k} may be shifted at least essentially perpendicularly (i.e. within 90°±45°, ±30°, ±15°, ±10°, ±5°, ±2.5°, ±1° or ±0°) to their respective vectors \vec{b}₁ and \vec{b}₂ until the conditions for S₁ (more generally Sᵢ) are obeyed. In other words, the lines B_{i,j} and B_{i,k} may define inner boundaries of the subtrahend surface Sᵢ, while the outer boundary may be provided by the boundary of the corresponding field of view Fᵢ, or preferably by the outer boundary of ISᵢ, wherein the terms “inner” and “outer” reference to the location being defined by the centre of the field of view Fᵢ of the respective i^{th} beam source, being herein denoted by an “x” representing the corresponding projection of the i^{th}-beam source.

In the example of FIG. 3, only two meandering lines are required to determine the subtrahend surface Sᵢ. In this example this is due to the location of the area A relative to the center of the first field of view F₁ (generally, center of the the i^{th}-field of view Fᵢ).

If the geometry and/or the location of the area A relative to an i^{th}-beam sources field of view Fᵢ is different, then three or four of the meandering lines may be required to determine the inner boundary of the subtrahend surface.

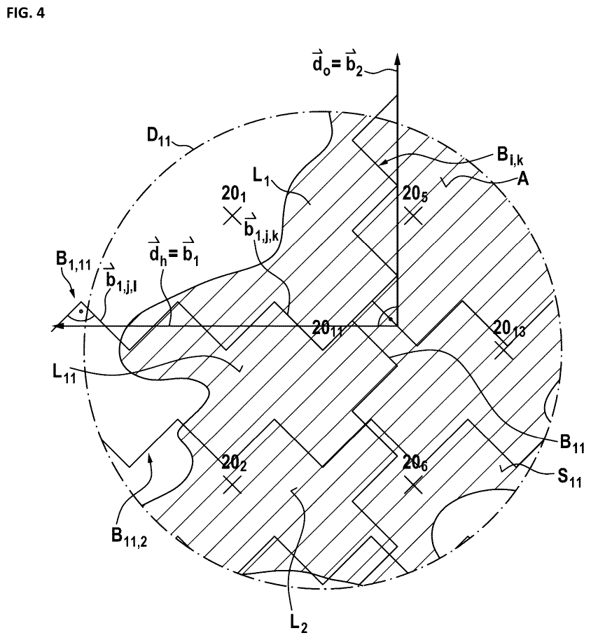

A corresponding example is shown in FIG. 4. FIG. 4 shows another detail of FIG. 2, being centred at the centre of the projection of the eleventh field of view F₁₁ of the 11^{th}-beam source. Again, the number 11 is just an example and may be generalized. When determining the 11^{th}-subtrahend surface S₁₁ one may again use meandering lines which in this case may be labelled B_{11,j},B_{11,k} and B_{11,l}. When determining S₁₁, the first set and second sets of locations L₁ and L₂ have already been determined and hence the 11^{th}-intersecting set IS₁₁ may be limited by B_{1,j′} and B_{2,j″}. As can be seen in FIG. 2, the left-hand portion of the surface being delimited by B_{1,j}, and B_{2,j″} may not be in the field of view Fᵢ or any other beam source than of the 11^{th}-beam source. Thus, the constraint on S₁₁ that ∀\vec{p}₁₁∈S₁₁, ∃Fₖ|\vec{p}₁₁∈Fₖ, k>i cannot be met for the points \vec{p}₁₁ in between of B_{1,j′}, B_{2,j″} and to the left of the circle defining the boundary of F_13. Thus, as matter of the conditions on Sᵢ it turns out that j′=j″=11 and one obtains B_{11,1}:=B_{1,11} and B_{11,2}:=B_{2,11}. Thereby, only the position of a single meandering line, B_{11,l} has to be determined by shifting it for example at least essentially perpendicular to \vec{b}₂, which in this example obeys \vec{b}₂⊥\vec{b}ₕ. In FIG. 4 this shifting process is indicated by a double headed arrow. In other words, the meandering line B_{11,l} (generally B_{i,l}) may be shifted until the remaining conditions on S₁₁ (as an example for Sᵢ are met). In the depicted example it is thus sufficient to determine the size of the surface being enclosed the contour of IS₁₁ and the meandering lines B_{11,5}, B_{11,6} and B_{11,l} to determine |IS₁₁−S₁₁| (generally |ISᵢ−Sᵢ|). If the size |IS₁₁−S₁₁| is bigger (or smaller) then (1±αᵢ)·tₒ(i)·Rᵢ, then the meandering line B_{11,l} may be slightly shifted to the left (or right, respectively) until (1−αᵢ)·(|ISᵢ|−tₒ·Rᵢ)≤|Sᵢ|≤(1+αᵢ)·(|ISᵢ|−tₒ·Rᵢ).

The method may next proceed with determining the next subtrahend surface Sᵢ₊₁ (in the given example with S₁₁₊₁=S₁₂).

The example method can be implemented particularly easy, if the sequence of determining the subtrahend surfaces Sᵢ may be selected based on the ability of the i^{th}-beam source to contribute to fusing the area A. A measure for this ability to contribute can be considered as the size of the overlap of their respective fields of view Fᵢ with the area A. Thus, as can be seen immediately, in the example of FIG. 2, |F₁∩A|≤|F₂∩A| or generally |Fᵢ∩A|≤|F₁₊₁∩A|, ∀1≤i<n. In case |Fᵢ∩A|=0 then Lᵢ={} and it does not matter in which step of the sequence this result is assigned or determined. Thus, in a preferred example, the sequence of determining the subtrahend surfaces Sᵢ and hence the sets of locations Lᵢ preferably starts with the index representing the beam source having the field of view Fᵢ with the smallest overlap with the area A and the indices are preferably sorted such that the |Fᵢ∩A|=|ISᵢ| increases with i. Only to avoid any misunderstandings, it is repeated that of course if |ISᵢ|=0 then it does not matter at which point in the method Lᵢ:={} is executed, it may be at the beginning, at the end or at any other point in time.

It will be appreciated to those skilled in the art having the benefit of this disclosure that this invention is believed to provide a method for manufacturing a workpiece, a storage medium including a program and an additive manufacturing apparatus. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### List of Reference Numerals

1 additive manufacturing apparatus
2 double headed arrow indicating movement of support 82
3 inert gas flow
5 process chamber
6 workpiece (partially manufactured)
7 side walls of process chamber 5
8 bottom of process chamber 5
81 opening in bottom 8
82 movable supported support
9 ceiling of process chamber 5
10 programmable electronic circuitry/controller
12 fusible material
14 top surface of fusible material
20ᵢ i^{th}-beam source/projection of i^{th}-beam source
22ᵢ i^{th}-beam spot of i^{th}-beam source 20ᵢ
Fᵢ fields of view of the i^{th}-beam source
Lᵢ set of locations {\vec{l}ᵢ} to be fused by the i^{th}-beam source 20ᵢ
\vec{d}ₕ horizontal component of inter gas flow in process chamber 5
\vec{d}ₒ vector at least essentially perpendicular \vec{d}ₕ
\vec{b}_{1,j,e} vector
\vec{b}_{1,j,l} vector
\vec{b}_{1,j,k} vector
\vec{b}_{2,j,e} vector
\vec{b}_{2,j,l} vector
\vec{b}_{2,j,k} vector
B_{i,j} meandering lines (i, j≤n, i≠j)

1. A method comprising:
fusing an area (A) of a layer of a fusible material by irradiating the surface of the area (A) of the layer using a number of n, n≥2 of at least two beam sources (i, j) to project a corresponding number of n beam spots on n sets of locations (Lᵢ, Lⱼ) of said surface area (A) of the layer,
wherein the area (A) is separated into at least 2n stripes extending essentially parallel to a horizontal component of an inert gas flow established across the fusible material,
wherein said fusing includes fusing at the same time only locations at every second stripe of the at least 2n stripes,
wherein i, j are indices, Lᵢ is a set of locations irradiated by an i^{th} beam source, Lⱼ is a set of locations irradiated by an j^{th} beam source, and wherein i≠j,i,j∈I, and I={1, . . . , n}.

2. A method according to claim 1, wherein said irradiating includes forming first and second beams spots, of the n beam spots, that are separated by at least a distance corresponding to a width of a stripe located between two stripes that being fused at the same time.

3. A method according to claim 1, further comprising defining a boundary between first and second of the at least 2n stripes by a corresponding meandering line B_{i,j} parallel to a first direction \vec{b}₁.

4. A method according to claim 1, wherein:
each beam source i, j has a predefined fuse rate (R_{I}, Rⱼ) and a field of view (F_{I}, Fⱼ), and
$$\vert {L}_{i} ∩ {L}_{j} \vert \leq \frac{1}{4} Max ( \vert {L}_{I} \vert , \vert {L}_{j} \vert ) , ∀ i \neq j ,$$
the predefined i^{th} fuse rate Rᵢ and the i^{th} field of view Fᵢ correspond to a respective i^{th} beam source, and an index j, the predefined j^{th} fuse rate Rⱼ, and the j^{th} field of view Fⱼ correspond to a respective j^{th} beam source.

5. A method according to claim 4, further comprising at least the following steps:
5.1 estimating an optimum fusing time tₒ(i) and/or a size of an optimum fusing area |Lᵢ^{opt}|, for the area (A) at least for a first beam source represented by a first index i=1,
5.2 determining intersecting sets (ISᵢ) of the surface area (A) and fields of view (Fᵢ) for at least the first index i=1 by assigning ISᵢ:=A∩Fᵢ at least for i=1;
5.3 comparing a size of the intersecting sets (|ISᵢ|) to a product of the optimum fusing time tₒ(i) with the predefined fuse rate Rᵢ of the corresponding i^{th} beam source and/or to an optimum size of the fusing area |Lᵢ^{opt}| and, in response to at least one of relations t₀(i)·Rᵢ<|ISᵢ| and |Lᵢ^{opt}|<|ISᵢ| holding true, performing the following steps:
5.3.1 determining a subtrahend surface Sᵢ with Sᵢ⊂ISᵢ and at least one of (1−αᵢ)(|ISᵢ|−tₒ(i)·Rᵢ)≤|Sᵢ|≤(1+αᵢ)(|ISᵢ|−tₒ(i)·Rᵢ), and (1−αᵢ)(|ISᵢ|−|Lᵢ^{opt}|)≤|Sᵢ|≤(1+αᵢ)(|ISᵢ|−|Lᵢ^{opt}|), wherein αᵢ∈{0.25, 0.2, 0.15, 0.1, 0.05, 0.025, 0.01, 0.005, 0} under the condition that for each \vec{p}ᵢ∈Sᵢ, ∃Fₖ|\vec{p}ᵢ∈Fₖ, wherein k is an index such that k>i, \vec{p}ᵢ is a point of the subtrahend surface Sᵢ, and
5.3.2 assigning Lᵢ:=ISᵢ−Sᵢ;
and
5.4. in response to step 5.3.2 having been carried out, fusing the fusible material at the locations of Lᵢ using the i^{th} beam source after step 5.3.2.

6. The method according to claim 5, wherein, in response to at least one of the relations in step 5.3 not holding true, the method further comprises at least the steps of:
6.1 determining a subtrahend surface Sᵢ with Sᵢ⊂ISᵢ under a condition that for each \vec{p}ᵢ∈Sᵢ, ∃Fₖ|\vec{p}ᵢ∈Fₖ, k>i, and
6.2 assigning Lᵢ:=ISᵢ−Sᵢ.

7. The method according to claim 5, further comprising:
7.1 setting Lᵢ:={} if and only if ISᵢ={}, and/or
7.2 repeating at least one of:
step 5.1;
step 5.2;
step 5.3;
determining a subtrahend surface Sᵢ with Sᵢ⊂ISᵢ under a condition that for each \vec{p}ᵢ∈Sᵢ, ∃Fₖ|\vec{p}ᵢ∈Fₖ, k>i; and
assigning Lᵢ:=ISᵢ−Sᵢ for all remaining indices i∈I only in response to ISᵢ≠{}.

8. The method according to claim 5, wherein the step 5.3.1 further comprises:
8.1 defining at least a first meandering line B_{i,j} parallel to a first direction \vec{b}₁, wherein the first meandering line defines a boundary between adjacent sets of locations Lᵢ and Lⱼ;
8.2 using the first meandering line B_{i,j} to determine a first boundary of the subtrahend surface Sᵢ; and
8.3 shifting the first meandering line in a second direction \vec{b}₂ that reduces ΔSᵢ, wherein ΔSᵢ=|tₒ(i)·Rᵢ−|ISᵢ−Sᵢ||.

9. A non-transitory tangible storage medium comprising a program code that, when executed, instructs a controller of an additive manufacturing apparatus to execute the method of claim 1.

10. An additive manufacturing apparatus comprising a support, a number of n beam-sources, wherein n≥2 for fusing a fusible material and a controller configured to control operation of the n beam sources, whereinthe manufacturing apparatus further comprises the storage medium according to claim 9.

11. A method comprising:
dividing a forming region into a plurality of sub-regions, wherein the forming region has an area (A) of a layer of a fusible material configured to be irradiated by at least two beam sources,
during an operation of the at least two beam sources, establishing an inert gas flow over a top of the forming region,
while operating the at least two beam source simultaneously, coordinating repositioning of beam spots, formed by the at least two beam sources at the area (A), over the layer of the fusible material such that at any moment in time no beam spot of said beam spots is below a fume that has been generated by another beam spot of said beam spots.

12. The method according to claim 11, wherein the plurality of the beam sources includes n beam sources, wherein the sub-regions are dimensioned as c·n stripes extending at least essentially parallel to a horizontal component of the inert gas flow, wherein c is an integer with c≥2.

13. The method according to claim 11, wherein said coordinating the repositioning of the beam spots comprises defining a scanning sequence of the c·n stripes, wherein said scanning sequence comprises fusing only locations Lᵢ in every second stripe at the same time.

14. The method according to claim 11, further comprising:
fusing the area (A) of a layer of the fusible material by irradiating the surface of the area (A) of the layer using a number of n, n≥2, of said least two beam sources (i, j) to project a corresponding number of n beam spots on n sets of locations (Lᵢ, Lⱼ) of said surface area (A) of the layer,
wherein said fusing includes fusing at the same time only locations at every second sub-regions of said plurality of sub-regions,
wherein i, j are indices, Lᵢ is a set of locations irradiated by an i^{th} beam source, Lⱼ is a set of locations irradiated by an j^{th} beam source, and wherein i≠j, i, j∈I, and I={1, . . . , n}.

15. A method according to claim 14,
wherein the sub-regions are dimensioned as stripes extending at least essentially parallel to a horizontal component of the inert gas flow, and
wherein said irradiating includes forming first and second beams spots, by the at least two beam sources at the area (A), that are separated by at least a distance corresponding to a width of a sub-region located between two sub-regions that being fused at the same time.

16. A method according to claim 14, further comprising defining at least one meandering line parallel to a first direction \vec{b}₁, wherein the first meandering line defines a boundary between adjacent sets of locations Lᵢ and Lⱼ.

17. A method according to claim 16, wherein said fusing the area (A) of the layer of the fusible material at the set of locations Lᵢ comprises pivoting the i^{th} beam source while the i^{th} beam source projects an i^{th} beam spot to thereby move the i^{th} beam spot along lines being multiples of a fusing vector \vec{v}ᵢ, wherein the at least one meandering line consists of concatenated sections that are alternatingly orthogonal and parallel to the fusing vector \vec{v}ᵢ.

18. A method according to claim 11, wherein
each beam source i, j has a predefined fuse rate (Rᵢ, Rⱼ) and a field of view (Fᵢ, Fⱼ), and
$$\vert {L}_{i} ∩ {L}_{j} \vert \leq \frac{1}{4} Max ( \vert {L}_{I} \vert , \vert {L}_{j} \vert ) , ∀ i \neq j ,$$
and the predefined i^{th} fuse rate Rᵢ, and the i^{th} field of view Fᵢ correspond to a respective i^{th} beam source, and an index j, the predefined j^{th} fuse rate Rⱼ, and the j^{th} field of view Fⱼ correspond to a respective j^{th} beam source.

19. A method according to claim 18, further comprising at least the following steps:
19.1 estimating an optimum fusing time tₒ(i) and/or a size of an optimum fusing area |Lᵢ^{opt}|, for the area (A) at least for a first beam source represented by a first index i=1,
19.2 determining intersecting sets (ISᵢ) of the surface area (A) and fields of view (Fᵢ) for at least the first index i=1 by assigning ISᵢ:=A∩Fᵢ at least for i=1;
19.3 comparing a size of the intersecting sets (|ISᵢ|) to a product of the optimum fusing time tₒ(i) with the predefined fuse rate Rᵢ of the corresponding i^{th} beam source and/or to an optimum size of the fusing area |Lᵢ^{opt}| and, in response to at least one of relations t₀(i)·Rᵢ<|ISᵢ| and |Lᵢ^{opt}|<|ISᵢ| holding true, performing the following steps:
19.3.1 determining a subtrahend surface Sᵢ with Sᵢ⊂ISᵢ and at least one of (1−αᵢ)(|ISᵢ|−tₒ(i)·Rᵢ)≤|Sᵢ|≤(1+αᵢ)(|ISᵢ|−tₒ(i)·Rᵢ), and (1−αᵢ)(|ISᵢ|−|Lᵢ^{opt}|)≤|Sᵢ|≤(1+αᵢ)(|ISᵢ|−|Lᵢ^{opt}|), wherein αᵢ∈{0.25, 0.2, 0.15, 0.1, 0.05, 0.025, 0.01, 0.005, 0} under the condition that for each \vec{p}ᵢ∈Sᵢ, ∃Fₖ|\vec{p}ᵢ∈Fₖ, wherein k is an index such that k>i, \vec{p}ᵢ is a point of the subtrahend surface Sᵢ, and
19.3.2 assigning Lᵢ:=ISᵢ−Sᵢ;
and
19.4. in response to step 19.3.2 having been carried out, fusing the fusible material at the locations of Lᵢ using the i^{th} beam source after step 19.3.2.

20. A non-transitory tangible storage medium comprising a program code that, when executed, instructs a controller of an additive manufacturing apparatus to execute the method of claim 11.

21. An additive manufacturing apparatus comprising: a support, a number n≥2 beam sources configured to fuse a fusible material, a controller configured to control operation of the n beam sources, and the non-transitory tangible storage medium of according to claim 20, said medium being operably connected with the controller.
